(19) United States
(12) Patent Application Publication
(10) Pub. No.: US 2006/0036760 A1
(43) Pub. Date: Feb. 16, 2006

(54) Stream transmitter, stream receiver, stream transmitting and receiving unit, and network system control method

(75) Inventor: Shigeto Oeda, Fujisawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/897,461

(22) Filed: Jul. 23, 2004

(30) Foreign Application Priority Data
Jun. 3, 2004 (JP) 2004-165253

(51) Int. Cl. G06F 15/173

(52) U.S. Cl. 709/238

(57) ABSTRACT

In a network system including a stream transmitter and a stream receiver, continuous use can be made of stream data that is the same as or similar to stream data subjected to reception or transmission interruption. The stream receiver includes stream selection unit capable of selecting stream data that is the same as or similar to stream data being received, communications function unit capable of switching to stream data selected by the stream selection unit, and stream switching unit.

### CLAIM OF PRIORITY

The present application claims priority from Japanese application serial no. JP2004-165253, filed on Jun. 3, 2004, the content of which is hereby incorporated by reference into this application.

### BACKGROUND OF THE INVENTION

The present invention relates to an information processing unit such as electrical household appliance and equipment or a personal computer connected to a network. In particular, the present invention relates to a method for controlling the transmission and reception of stream data in a network including a stream transmitter which transmits stream data such as video or audio information and a stream receiver which receives a stream transmitted and reproducing video and voice information and a stream transmitting and receiving unit.

Conventional methods for controlling stream data include data formatting and controlling methods for transmitting and receiving video or audio (voice) information as stream data between a stream transmitter and a stream receiver, such as an MPEG 2 transport stream widely used in digital broadcasting. These data formatting and controlling methods are proposed and utilized in various types.

For a method for simultaneously receiving a plurality of stream data on a single stream receiver, wide use is also made of a configuration where two or more stream data are utilized simultaneously. A receiver for digital broadcasting use, for example, is provided with stream acquisition unit (a tuner) for receiving a plurality of stream data so as to use two or more stream data simultaneously. Similarly, wide use is also made of a configuration where a stream receiver simultaneously obtains and utilizes a plurality of stream data in transmitting and receiving stream data over the Internet.

For the above-mentioned simultaneous utilization of a plurality of stream data, Japanese Patent Laid-open No. 2002-354029 describes a control method for preventing inaccurate synchronization and reproduction operations due to a delay in the transmission of stream data.

### SUMMARY OF THE INVENTION

The above-mentioned conventional arts make it possible to prevent the poor synchronization and poor reproduction of stream data simultaneously utilized in a stream receiver which simultaneously receives and utilizes a plurality of stream data. However, these conventional arts are intended to simultaneously utilize a plurality of stream data, not giving any special consideration to improvements in reception control reliability for individual streams or improvements in the quality of received stream data.

It is an object of the present invention to improve the reliability of reception control, thereby improving the quality of individual received stream data.

It is another object of the present invention to improve the quality of received stream data by receiving stream data by means of at least two stream receivers and utilizing the received stream data under cooperative control of the at least two stream receivers.

To solve the above-mentioned problem, the present invention most characteristically provides a method that allows the selective reception of stream data, under a situation where a reduction in the quality of received stream data can be found or predicted, in a network system capable of transmitting and receiving stream data.

In a first aspect of the present invention, a stream receiver therefore includes communications function unit capable of receiving a plurality of stream, stream comparison unit capable of comparing reproduction and synchronization information such as time stamp information on the plurality of stream, stream switching unit capable of selecting stream data utilized according to a comparison result of the stream comparison unit, and stream selection unit capable of selecting stream data containing part of at least same, similar or associated video and voice information.

The stream selection unit of the present invention obtains or predicts a situation associated with a fluctuation in the quality of received stream data, such as an advance notice of stream data transmission interruption from a stream transmitter and selects stream data candidate that is the same as or similar to received stream data. The communications function unit simultaneously receives one or more stream data selected by the stream selection unit from a plurality of stream transmitters or a common stream transmitter. The stream comparison unit compares reproduction and synchronization information on a plurality of stream data obtained and notifies stream switching unit of an optimum stream data switching timing based on the reproduction and synchronization information. The stream switching unit switches received stream data utilized according to a switching notice from the stream comparison unit and received stream data designated by the stream selection unit.

In a second aspect of the present invention, a stream transmitter includes transmitted-stream linking unit capable of synchronizing and linking stream data transmitted among a plurality of stream transmitters. The transmitted stream linking unit of the present invention selects a stream transmitter B capable of obtaining or predicting a situation associated with a fluctuation in the quality of transmitted stream data and transmitting stream data containing part of video or audio information that is at least the same as, similar to or associated with the transmitted stream data and performs control for mediation with transmitted-stream linking unit of the stream transmitter B in terms of transmitted stream data, thereby switching a stream transmitter which transmits stream data.

In a third aspect of the present invention, two or more stream receivers receives at least part of the same stream data and coordinately utilizes two or more received stream data to improve the quality of received stream data. In this aspect of the present invention, the stream receiver comprises received-stream linking unit which performs adjustable control on the received stream data among the plurality of stream receiver, and stream switching unit capable of performing control operations for switching and interrupting streams received according to instructions from the received-stream linking unit.

The received-stream linking unit of the present invention notifies another stream receiver B of received stream data, determines whether the stream receiver B can receive stream data that is the same as, similar to, or associated with the received stream data. This unit then coordinately controls a stream receiver capable of receiving such a stream according to a result of determination. The received-stream linking unit therefore requests other stream receivers to receive at least part of the stream data.

In the above configurations for solving the above-mentioned problem, there are a stream receiver and a stream transmitter provided. However, the present invention is also applicable to a stream transmitting and receiving unit having a stream receiving function and a stream transmitting function and the like. The configuration of a stream unit is not limited to any of the above-mentioned configurations.

According to the first aspect of the present invention, the stream receiver can obtain and predict information on a fluctuation in the quality of received stream data and switchably receive the received stream data and stream data from another stream transmitter that is the same as, similar to, or associated with the received stream data or another stream data from the same stream transmitter that is the same as, similar to, or associated with the received stream data. In addition, switching can be made between stream data before switching and stream data after switching according to a reproduction and synchronization signal for both of these stream data, thus preventing a deterioration in the quality of received stream data before and after switching. Switching received stream data also makes it possible to prevent a reduction in the quality of stream data due to quality fluctuation.

According to the second aspect of the present invention, a stream transmitter can obtain and predict information on a fluctuation in the quality of transmitted stream data during stream data transmission and request another stream transmitter to switch the transmission of same or similar or associated stream data. This makes it possible to prevent a reduction in the quality of transmitted stream data.

According to the third aspect of the present invention, a plurality of stream receivers can be linked to each other and receive the same stream data. In addition, a plurality of received stream data are coordinately utilized between and among the stream receivers. This makes it possible to improve the quality of received stream data.

According to the present invention, it is possible to improve the quality of received stream data.

### BRIEF DESCRIPTION OF THE DRAWINGS

FIG. 1 shows a system configuration according to a first embodiment of the present invention;

FIG. 2 is a block diagram of hardware according to the first embodiment of the present invention;

FIG. 3 is a block diagram of a stream receiver according to the first embodiment of the present invention;

FIG. 4 is a block diagram of a stream transmitter according to the first embodiment of the present invention;

FIG. 5 is a block diagram of stream data processing according to the first embodiment of the present invention;

FIG. 6 is a diagram of a flow sequence for processing according to the first embodiment of the present invention;

FIG. 7 is a schematic diagram of an operation according to the first embodiment of the present invention;

FIG. 8 is a block diagram of a stream receiver according to the first embodiment of the present invention;

FIG. 9 is a diagram of a flow sequence for processing according to the first embodiment of the present invention;

FIG. 10 is a block diagram of a stream transmitter according to the first embodiment of the present invention;

FIG. 11 is a block diagram of a stream receiver according to the first embodiment of the present invention; and

FIG. 12 is a diagram of a flow sequence for processing according to the first embodiment of the present invention.

### DESCRIPTION OF THE PREFERRED EMBODIMENTS

Preferred embodiments of the present invention will be described below with reference to the accompanying drawings.

### First Embodiment

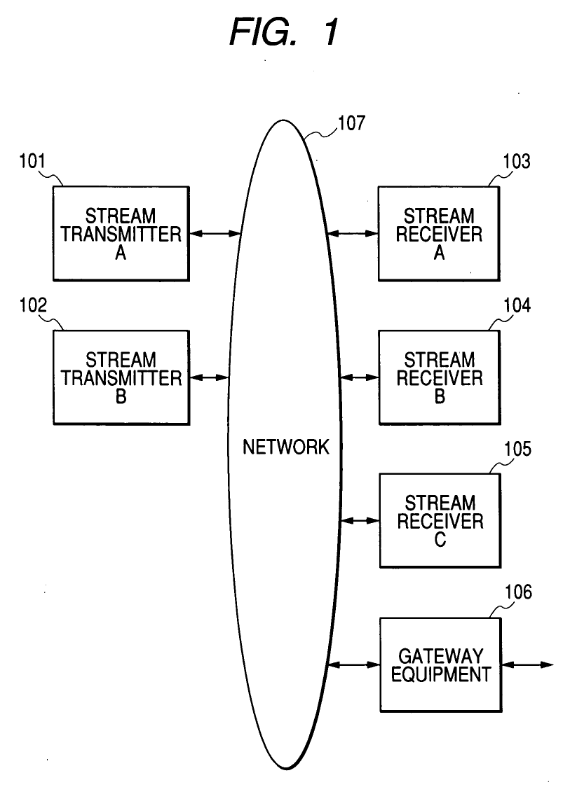

A first embodiment of the present invention is described with reference to FIGS. 1 to 7.

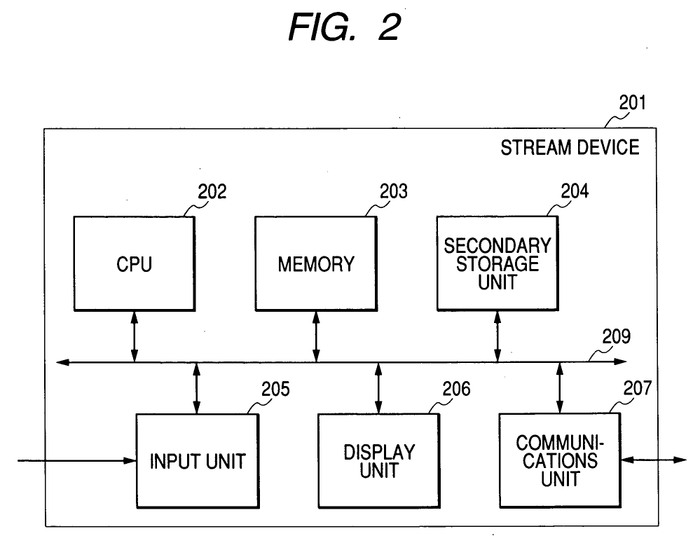

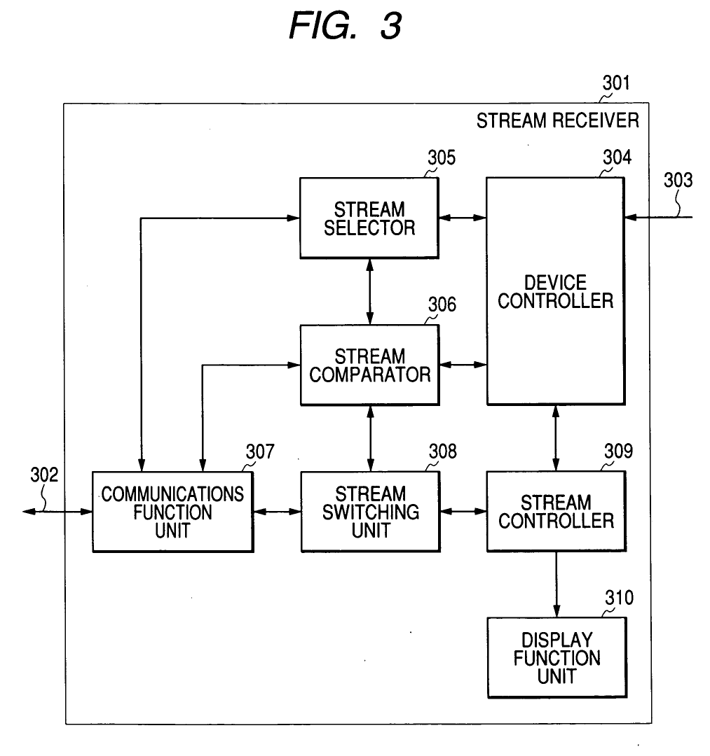

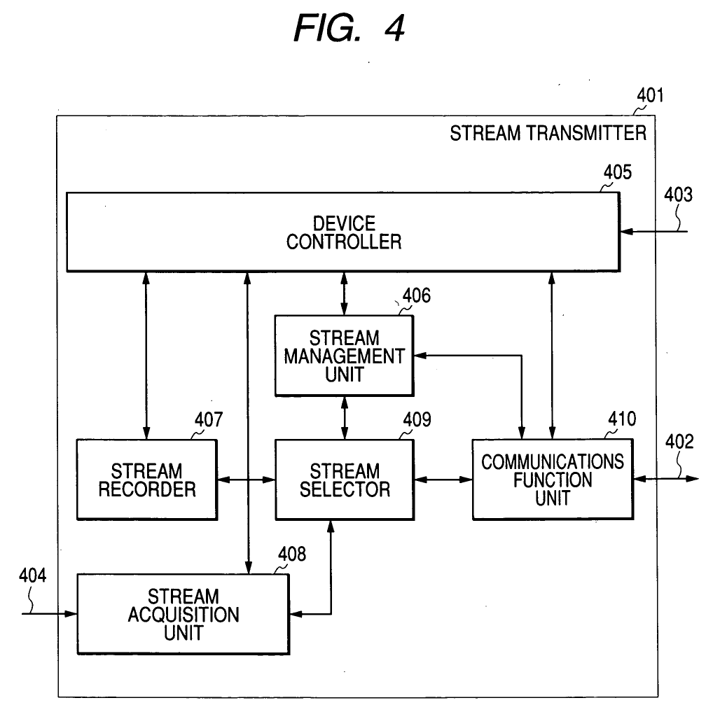

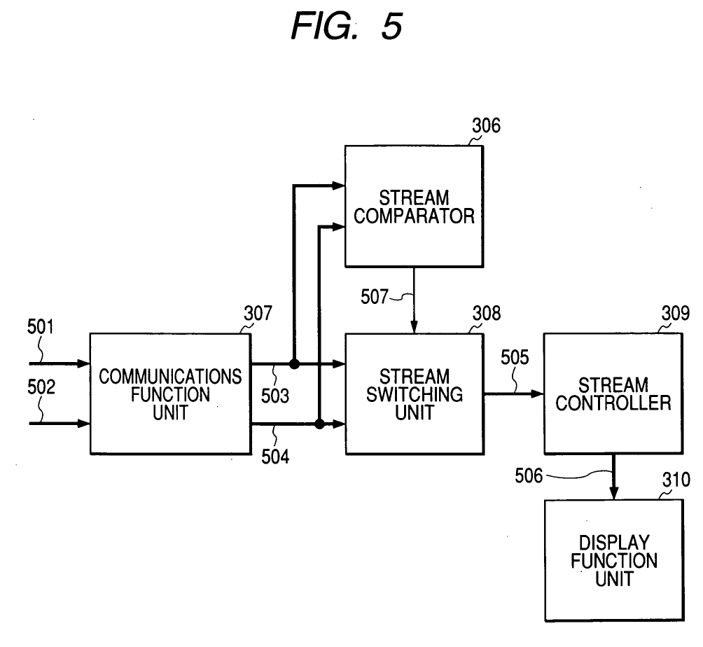

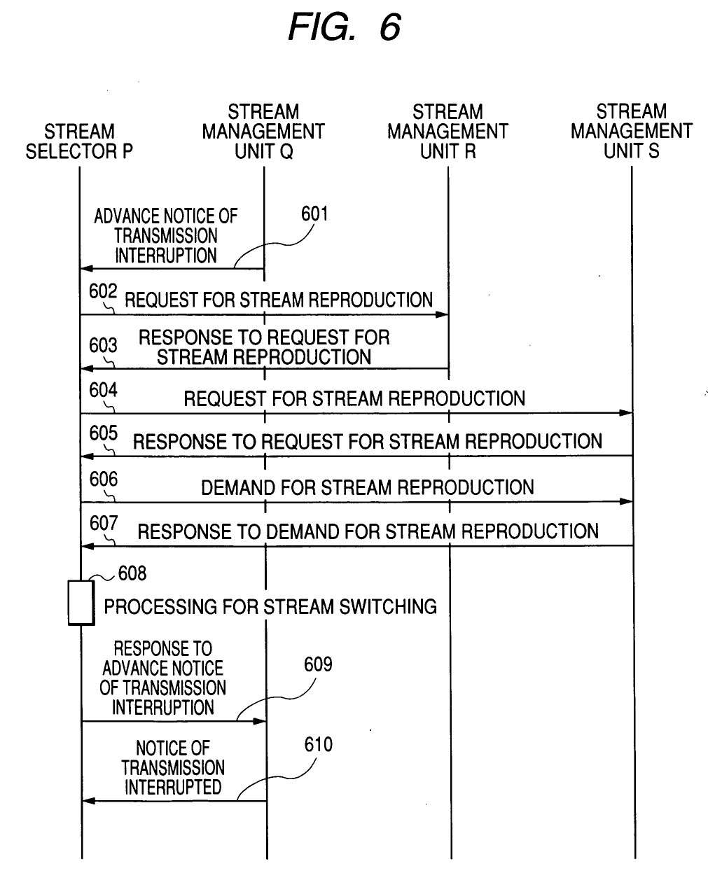

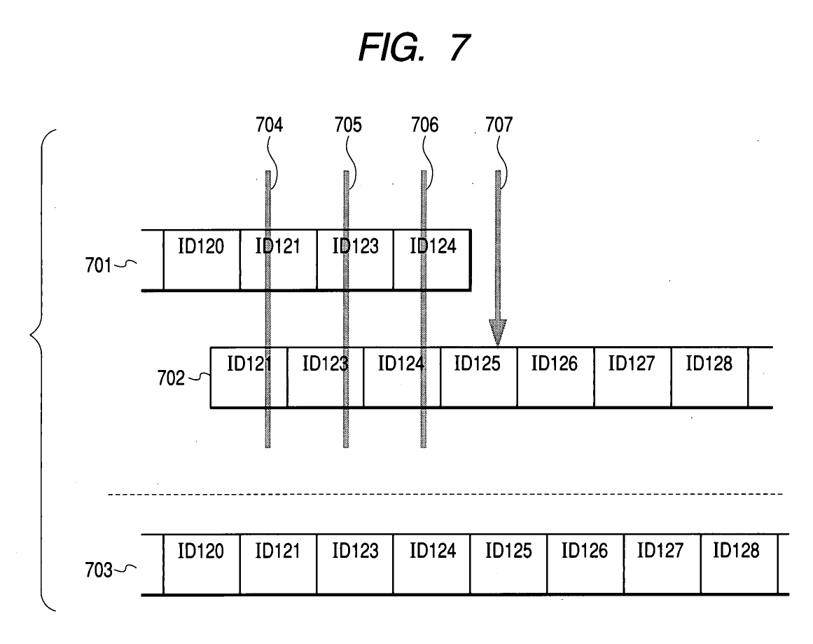

FIG. 1 is a system diagram showing the configuration of a stream transmitting and receiving system including a stream transmitter, a stream receiver, and a gateway unit for controlling access to another network, according to the present invention. FIG. 2 is a block diagram showing a hardware configuration of a stream receiver or stream transmitter of the present invention. FIG. 3 is a block diagram showing a functional configuration of a stream receiver. FIG. 4 is a block diagram showing a functional configuration of a stream transmitter. FIG. 5 is a block diagram showing a flow of stream data received by a stream receiver. FIG. 6 is a sequence diagram showing processing flows for a stream selector and a stream management unit. FIG. 7 is an operational schematic view showing processing by a stream switching unit.

In FIG. 1, reference numerals 101 and 102 denote stream transmitters. Reference numerals 103, 104, and 105 denote stream receivers. Reference numeral 106 denotes gateway equipment for managing connections to another network. Reference numeral 107 denotes a network for connecting and allowing all of the above-mentioned equipment to transmit and receive data to and from one another.

In FIG. 2, reference numeral 201 denotes a stream unit such as a stream receiver or stream transmitter. Reference numeral 202 denotes a CPU for controlling the entire unit. Reference numeral 203 denotes a memory such as a ROM and a RAM for storing programs, data and the like. Reference numeral 204 is a secondary storage unit such as a hard disk. Reference numeral 205 denotes an input unit such as a keyboard or mouse. Reference numeral 206 is a display unit including a display device such as a liquid-crystal display and a display controller for controlling the display device. Reference numeral 207 denotes a communications unit connected to a network for controlling data transmission and reception.

In FIG. 3, reference numeral 301 denotes a stream receiver according to this embodiment. Reference numeral 302 denotes data transmitted and received to and from a network; 303, an external input such as a user input to a device controller 304; 304, the device controller for controlling the entire stream receiver; 305, a stream selector for selecting stream data to be received; 306, a stream comparator for comparing a plurality of stream data received by a communications function unit 307; 307, the communications function unit for transmitting and receiving data to and from another unit via a network; 308, a stream switching unit for switching stream data inputted into a stream controller according to a comparison result of the stream comparator 306; 309, a stream controller for decoding stream data outputted from the stream switching unit 308; and 310, a display function unit for displaying and reproducing the stream data decoded by the stream controller 309.

Each of the functions shown in FIG. 3 is implemented by the stream unit having a hardware configuration shown in FIG. 2. One method for mounting one function is by configuring any of the functions shown in FIG. 3 through a program, storing the program in the memory 203, and then executing the program on the CPU 202. Another method for mounting a function could be by providing part of any function through software and the rest of the function by means of hardware, for example, such as providing part of a communications function through a program and the rest of the function by means of the communications function unit 307. Still another method four mounting a function could be by providing all parts of any function as hardware. In addition, each of the methods mentioned above could be selected independently of one another for each given function. It would be possible, for example, to provide all of stream control unit by means of hardware, communications function unit by means of mixture of a program and hardware, and the other functions by means of software. In this embodiment, methods for providing individual given functions are not limited to what is described herein.

In FIG. 4, reference numeral 401 denotes a stream transmitter according to this embodiment. Reference numeral 402 denotes data transmitted and received to and from a network; 403, an external input such as a user input to a device controller 405; 404, a stream data input from external stream provision unit such as broadcasting station equipment; 405, the device controller for controlling the entire stream transmitter; 406, a stream management unit for managing the selection of stream data to be transmitted and the like; 407, a stream recorder for keeping stream data obtained through a stream acquisition unit 408 or communications function unit 410; 409, a stream selector for selecting stream data designated by the stream management unit 406; and 410, the communications function unit for transmitting and receiving data to and from another unit via a network. Each of the functions shown in FIG. 4 can be provided by means of the stream unit having the hardware configuration shown in FIG. 2. For a method for providing each of the functions, a selection could be made of a plurality of methods as with the stream receiver shown in FIG. 3. A method for providing any of the functions shown in FIG. 4 is not particularly limited to what is described herein.

Operations for processing according to this embodiment are described with reference to FIGS 5, 6, and 7. In FIG. 5, the stream selector 305, not shown in this figure, selects stream data and notifies a communications function unit 307 of the stream data selected. Normally, the stream selector 305 notifies the communications function unit 307 that the selector has received a given stream data A1 designated by a user or program. The communications function unit 307 will receive the stream data A1 designated. The communications function unit 307 can predict or determine that there may be a reduction in the quality of the stream data A1 being received or that the stream data A1 will be difficult to continuously receive, such as a notice from a stream transmitter that transmitted the stream data. At the point, the stream selector 305 decides stream data A2 that is the same as, similar to or associated with the stream data A1 being received and instructs the communications function unit 307 to receive the stream data A2. The communications function unit 307 then receives the stream data A1 and, at the time, starts receiving the stream data A2.

FIG. 5 shows a stream data flow for the stream receiver in the above-mentioned state. Reference numeral 501 denotes stream data A1 and reference numeral 502 denotes stream data A2. The communications function unit 307 receives each of the stream data A1 and A2 and provides the stream comparator 306 and the stream switching unit 308 with the stream data A1 503 and the stream data A2 504 as data processable in the stream receiver.

The stream comparator 306 compares the stream data A1 503 and the stream data A2 504, determines whether each of these stream data meets the prescribed requirements, and notifies the stream switching unit 308 of a result determination as determination information 507. The stream switching unit 308 switches the stream data A1 503 and the stream data A2 504, based on the determination information 507. The stream controller 309 is notified of the switched stream data and decompresses the compressed stream data to convert the stream data to a reproducible stream data. The stream data converted 506 is displayed as a video image on the display function unit 310 or reproduced as audio data.

The operation of the stream selector 305 is now described with reference to FIG. 6. A stream selector P denotes the stream selector 305 of a stream receiver P. Stream management units Q, R, and S denote a stream transmitter P stream management unit 406, a stream transmitter Q stream management unit 406, and a stream transmitter S stream management unit 406, respectively. FIG. 6 shows the operation of the stream receiver 301 P receiving the stream data A1 from the stream transmitter 401 Q. At processing stage 601, the stream receiver 301 is notified of a notice of transmission interruption by the stream management unit 406 Q of the stream transmitter 401 Q. At processing stage 602, the stream selector 305 of the stream receiver 301 P notifies the stream management unit 406 R of the stream transmitter 401 R, as a request for stream reproduction, that the same stream data as the stream data A1 has been transmitted. At processing stage 603, the stream management unit 406 R notifies the stream receiver 301 P, as a response to the request for stream reproduction, that the stream management unit will not transmit the stream data designated.

As a result, the stream selector 305 of the stream receiver 301 P, at processing stage 604, similarly notifies the stream management unit 406 S of the stream transmitter 401 S, as a request for stream reproduction, that the same stream data as the stream data A1 has been transmitted. At processing stage 605, the stream management unit 406 S notifies the stream receiver 301 P, as a response to the request for stream reproduction, that the stream management unit 406 S can transmit the stream data designated. At processing stage 606, the stream receiver 301 demands the transmission of the same stream data A2 as the stream data A1 from the stream transmitter 401 S. At processing stage 607, the stream transmitter 401 S accepts the transmission of the stream data A2 and starts transmitting the same stream data A2 as the stream data A1.

At processing stage 608, the stream switching unit 308 completes switching the stream data A1 and the stream data A2, which switching step will be described later in details, and the stream data to be inputted into the stream controller 309 of the stream receiver 301 P is switched to the stream data A2. At processing stage 609, the stream receiver 301 sends a response to an advanced notice of transmission interruption received at processing stage 601 back to the stream management unit 406 Q of the stream transmitter 401 Q to notify the unit 406 Q that the receiver 301 will consent to the interruption. At processing stage 610, the stream management unit 406 Q of the stream transmitter 401 Q notifies the stream receiver 3011 that the transmission of the stream data A1 503 has been interrupted.

The operation of the stream comparator 306 and the stream switching unit 308 is described below with reference to FIG. 7. In FIG. 7, Reference numeral 701 denotes stream data A1 503; 702, stream data A2 504; and 703, stream data outputted from a stream switching unit 308. The stream switching unit 308 compares the two input streams 503 and 504 shown in FIG. 5. In an example shown in FIG. 7, input stream data 701 corresponds to the stream data A1 and input stream data 702 corresponds to the stream data A2. When two stream data 701 and 702 are inputted, the stream comparator 306 compares reproduction and synchronization information such as time stamp information, i.e., time synchronization information used for the reproduction of the stream data 701 and 702 to detect a coincidence between the synchronization information of the input stream data 701 and that of the input stream data 702 within a prescribed error range. The comparator 306 then notifies the stream switching unit 308, as determination information 507, that the comparator has detected the coincidence.

In response to the determination information 507 on the coincidence, the stream switching unit 308 switches stream data 503 and 504 and notifies the stream controller 309 of a resultant switched stream data 505. In FIG. 7, stream data 703 corresponds to the switched stream data 505 outputted by the stream switching unit 308.

For the operation of the stream comparator 306 and the stream switching unit 308, the stream comparator 306 compares the stream data A1 and stream data selected as stream data A2 according to the reproduction and synchronization information, as described above. The stream data A2 504 takes the place of the stream data A1 503 being received by the stream selector 305, as the operation flow is shown in FIG. 6. In a case of a coincidence in reproduction and synchronization information between stream data A1 and A2 within a prescribed error range, the stream comparator 306 notifies the stream switching unit 308 of the detected coincidence in synchronization information as determination information 507. This allows the stream switching unit 308 to switch received stream data from the stream data A1 to the stream data A2 while controlling a reduction in image and sound quality of received stream data for user or program use due to stream data switching. Transmission interruption and data deterioration will not be predicted or determined for the stream data A2 as they may be for the stream data A1.

For example, the stream data 505 for user or program use after switching will not suffer from a reduction in image and sound quality even at the time of stream data switching performed by the stream switching unit 308, where the stream comparator 306 immediately notifies the stream receivers 301 of any coincidence between two stream data in reproduction and synchronization information as determination information 507. There is also no difference in image and sound quality between before switching and after switching.

Note that two or more stream data could be switched though each of the stream selector 305, the stream comparator 306, the stream switching unit 308, and the communications function unit 307 switches two stream data in this embodiment. The number and type of stream data subjected to switching control is not particular limited to those described herein.

While this embodiment involves switching and utilizing the same stream data, it is also possible to switch and utilize similar or associated stream data. The type of stream data switched by a stream selector and switching information for stream data compared by a stream comparator are not particular limited to what is described herein.

While the stream selector 305 obtains information on stream data, in this embodiment, from the stream transmitter and determines which stream data to receive, it may be also possible to select a decentralized control method by which a stream selector determines which stream data to receive, in connection with a stream selector of another stream receiver. It may be also possible to allow both of the stream transmitter and the stream receiver to obtain information on stream data and determine which stream data to receive.

While the stream comparator detects a coincidence in reproduction and synchronization information in this embodiment, the stream comparator could also detect such a coincidence based on other types of comparison information and comparison requirements, such as detecting the coincidence and notifying the stream receiver of it at the start of data A2 reception. Comparison information for the stream comparator and comparison methods are not particularly limited to what is described herein.

### Second Embodiment

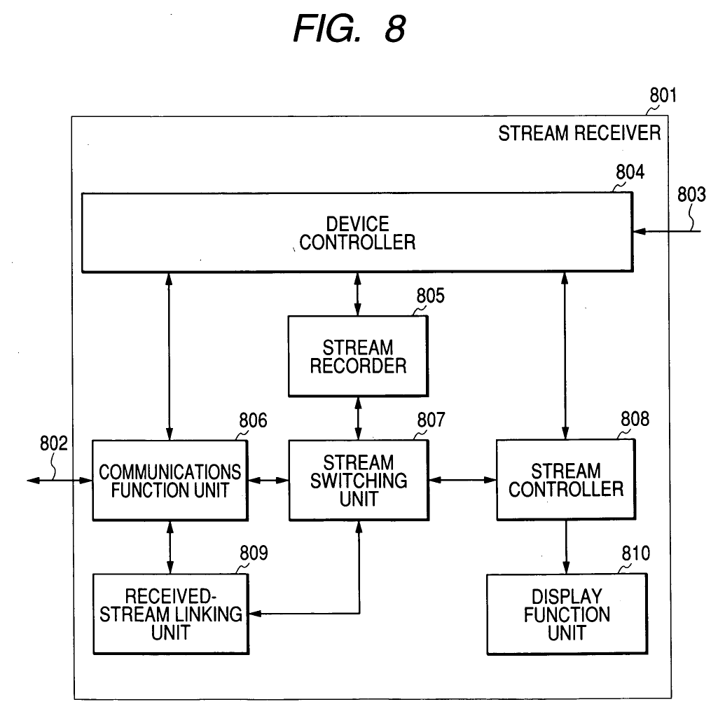

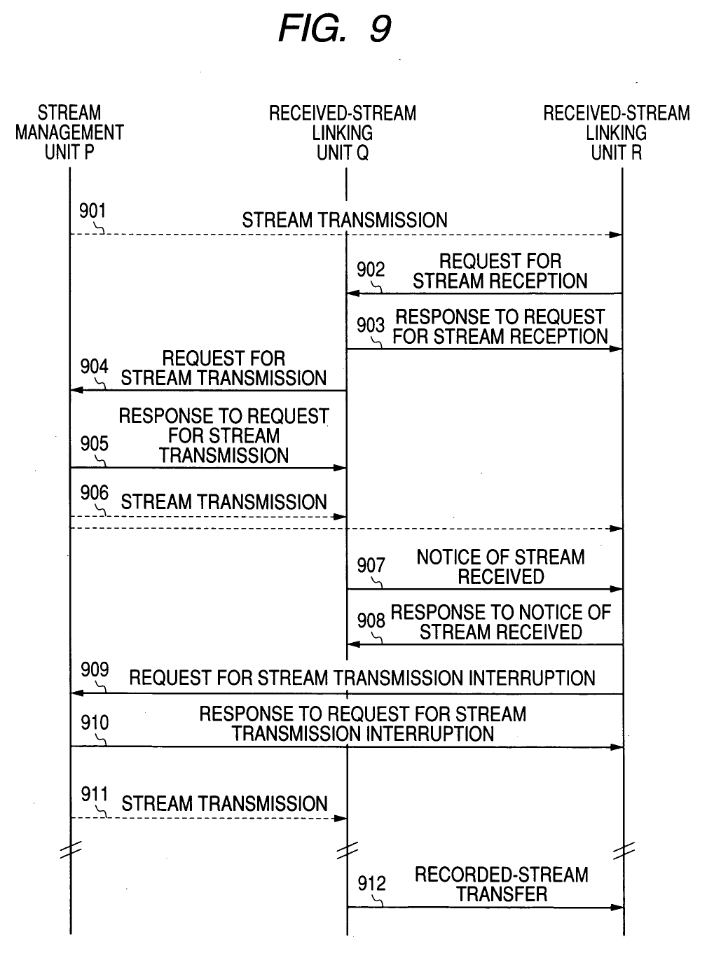

A second embodiment of the present invention will be described below with reference to FIGS. 8 and 9.

FIG. 8 is a block diagram showing the configuration of a stream receiver according to this embodiment and FIG. 9 is a sequence diagram showing a processing flow for a received-stream linking unit of the stream receiver.

In FIG. 8, reference numeral 801 denotes a stream receiver according to this embodiment; 802, data transmitted and received to and from a network; 803, an external input such as a user input to a device controller 804; 804, the device controller for controlling the entire stream receiver; 805, a function unit for recording stream data; 806, a communications function unit for transmitting and receiving data to and from another unit via a network; 807, a stream switching unit for switching stream data inputted into a stream controller 808 according to instructions from a received-stream linking unit 809; 808, a stream controller for decoding stream data outputted by the stream switching unit 807; 809, a received-stream linking unit for determining which stream data to receive, in connection with a received-stream linking unit of another stream receiver; and 810, a display function unit for displaying and reproducing the stream data decoded by the stream controller 809.

Each of the functions shown in FIG. 8 can be provided by the stream unit having a hardware configuration shown in FIG. 2. One method for mounting one function is by describing any of the functions shown in FIG. 8 through a program, storing the program in the memory 203, and then executing the program on the CPU 202. Another method for mounting a function could be by providing part of any function through software and the rest of the function by means of hardware, for example, such as providing part of a communications function through a program and the rest of the function by means of the communications function unit 806. Still another method for mounting a function could be by providing all parts of any function as hardware.

In addition, each of the methods mentioned above could be selected independently of one another for each given function. It would be possible, for example, to provide all of stream control unit by means of hardware, communications function unit by means of mixture of a program and hardware, and the other functions by means of software. In this embodiment, methods for providing individual given functions are not limited to what is described herein.

The operation of this embodiment is described below with reference to FIG. 9 In FIG. 9, a stream management unit P denotes the stream management unit 406 of a stream transmitter 401 P. Received-stream linking unit Q and R denote a received-stream linking unit 809 of the stream receiver 801 Q and a received-stream linking unit 809 of the stream receiver 801 R, respectively. The stream transmitter 401 P and the stream receivers 801 Q and 801 R are connected to a network and can transmit and receive stream data to and from each other. In such a system configuration, the operation of the received-stream linking unit 809 is described with reference to an example where the stream receiver 801 R receives stream data from the stream transmitter 401 P. As the stream receiver 801 R becomes incapable of continuing to receive stream data, processing by the received-stream linking unit 809 starts beginning at processing stage 902.

The stream receiver 801 may become incapable of continuing to receive stream data due to the following case: a coincidence in requirements such as time between one processing the stream receiver 801 starts and another necessitates the interruption of the reception of stream data being received; recording unit such as DVD has a smaller area than required while it records stream data being, or received; or it is difficult for the stream receiver 801 to continuously receive stream data due to its failure. There are a wide variety of possible causes for the incapability of the receiver 801 to do the above job. These causes themselves are not particularly limited to what is described herein.

At processing stage 902, the stream receiver 801 R requests the stream receiver 801 Q to receive the same, similar, and associated stream data. In this embodiment, an example of a case where the stream receiver 801 Q can receive stream data designated is described. At processing stage 903, the stream receiver 801 Q notifies the stream receiver 801 R that the stream receiver 801 Q can receive stream data designated. At processing stage 904, the stream receiver 801 Q notifies the stream transmitter 401 P of a request for the transmission of the stream data designated. At processing stage 905, the stream transmitter 401 P notifies the stream receiver 801 Q, as a response to the request for stream transmission, that the transmitter can transmit the stream data designated.

At processing stage 906, the stream transmitter 401 P transmits the stream data designated to both of the stream receiver 801 Q and the stream receiver 801 R. After starting receiving the stream data designated, the stream receiver 801 Q notifies the stream receiver 801 R of the start of the reception of the stream data designated, at processing stage 907. At processing stage 908, the stream receiver 801 R sends a response to the notice of the start of the stream data designated back to the stream receiver 801 Q. At processing stage 909, the stream receiver 801 R requests the stream transmitter 401 P to interrupt the reception of the stream data designated. At processing stage 910, the stream transmitter 401 P notifies the stream receiver 801 R of a response to reception interruption. At processing stage 911, the stream transmitter 401 P interrupts the transmission of the stream data designated to the stream receiver 801 R.

For the aforementioned operation of the received-stream linking unit 809 shown in FIG. 9, the stream receiver 801 may interrupt the reception of stream data being received for some reason. Even in this case, another stream receiver 801 becomes capable of continuously receiving stream data that is the same as, similar to, or associated with the stream data that was being receiving, thus improving the reliability of the stream receiver 801.

In this embodiment, the stream receiver 801 Q and the stream receiver 801 R record stream data received. By using stream data recording function 805, at processing stage 912, the stream receiver 801 Q transfers stream data recorded to the stream receiver 801 R after completing receiving the stream data designated, thereby allowing the stream receiver 801 R to obtain the rest of the stream data that the stream receiver 801 R stopped receiving. For example, the stream receiver 801 R receives and merges the rest of the stream data and the stream data transferred from the stream receiver 801 Q, thus making it possible to obtain stream free of reception interruption. This allows the improvement in the reliability of stream data reception.

In this embodiment, the received-stream linking unit 809 R switches stream receivers 801 if the unit 809 R cannot continue to receive stream data. If a user starts using the stream receiver 801 Q while utilizing the stream receiver 801 R, it may also be possible to provide user detection unit and switch stream receivers 801. Causes for which the received-stream linking unit 809 switches received stream data are not particularly limited to what is described herein.

In this embodiment, the stream receiver 801 interrupts the reception of stream data and then obtains the rest of the stream data from another stream receiver 801 to merge the part of the stream data that the stream receiver 801 has received and the rest. However, it may be possible to reproduce only the part of the stream data that is obtained from the another stream receiver 801. The utilization and processing of stream data obtain is not particularly limited to what is described herein.

In this embodiment, the stream receiver 801 interrupts the reception of stream data and designates another stream receiver 801 to cause the another receiver to receive the rest of the stream data before obtaining the rest from the another receiver. It may also be possible for the receiver designated to receive and store the rest of the stream data and reproduce the original stream data from the rest. Methods for processing the stream data that the designated receiver 801 stores are not particularly limited to what is described herein.

### Third Embodiment

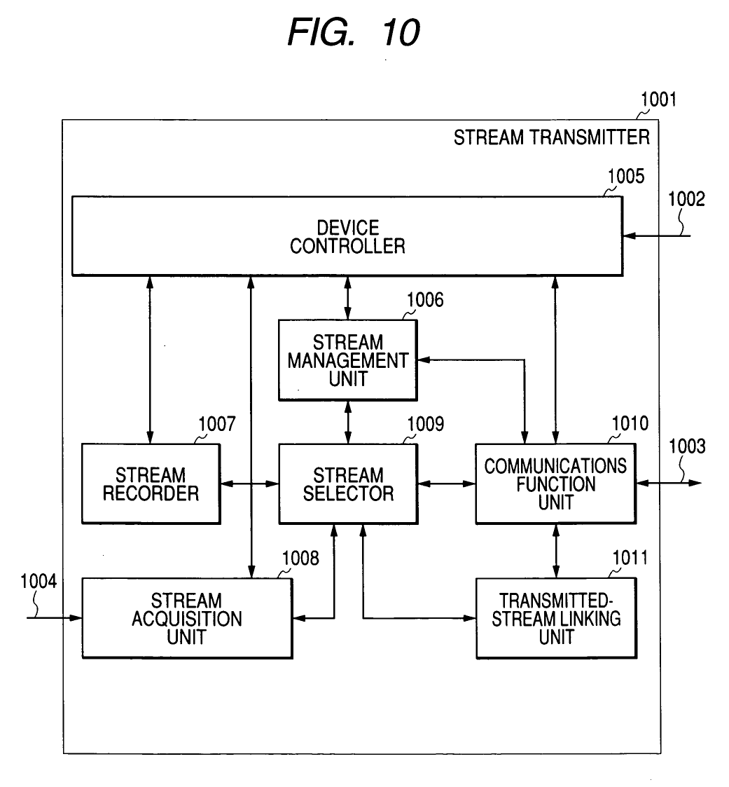

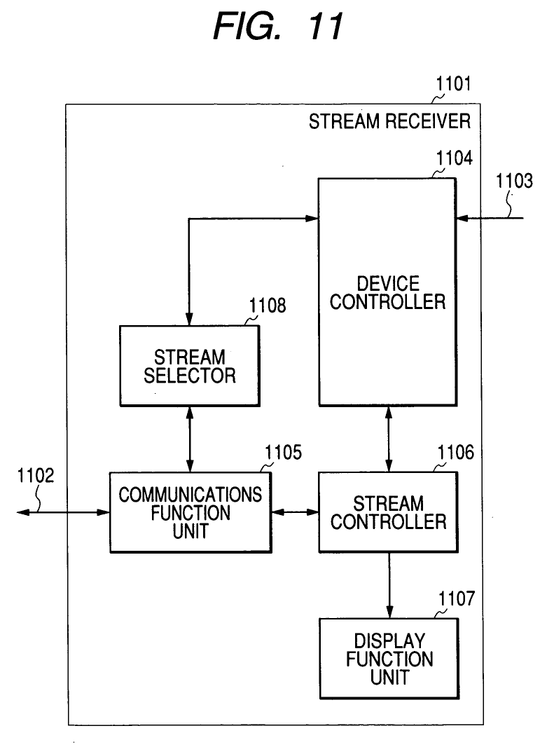

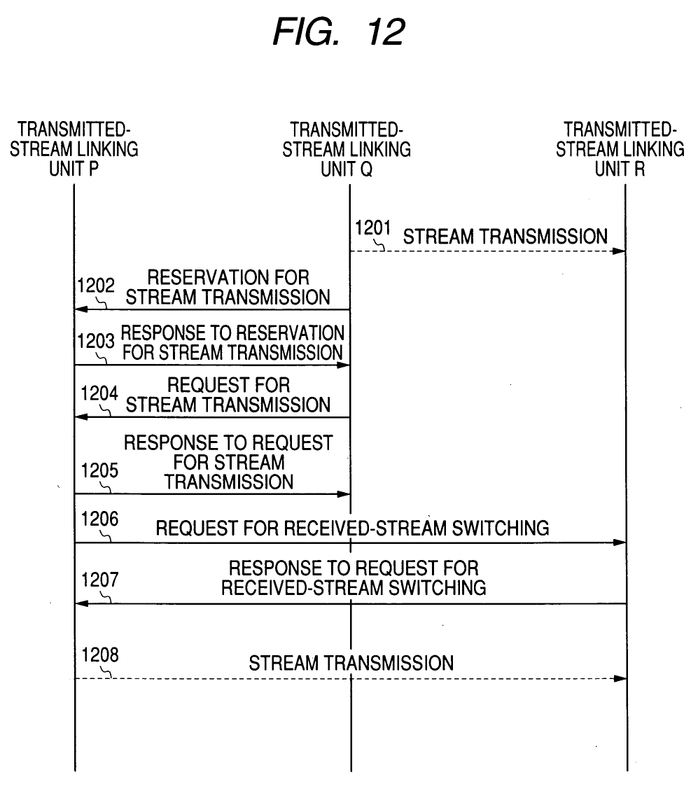

A third embodiment of the present invention will be described below with reference to FIGS 10, 11, and 12. FIG. 10 is a block diagram showing the configuration of a stream transmitter according to this embodiment, FIG. 11 is a block diagram showing the configuration of a stream receiver, and FIG. 12 is a sequence diagram showing a processing flow for a transmitted-stream linking unit according to this embodiment.

In FIG. 10, reference numeral 1001 denotes a stream transmitter according to this embodiment; 1003, data transmitted and received to and from a network; 1002, an external input such as a user input to a device controller 1005; 1004, a stream data input from external stream provision unit such as broadcasting station equipment; 1005, a device controller for controlling the entire stream transmitter; 1006, a stream management unit for managing the selection of stream data to be transmitted and the like; 1007, a stream recorder for keeping stream data obtained through a stream acquisition unit 1008 or communications function unit 1010; 1009, a stream selector for selecting stream data designated by the stream management unit 1006; 1010, a communications function unit for transmitting and receiving data to and from another unit via a network; and 1011, a transmitted-stream linking unit capable of processing the control of stream data to be transmitted in connection with another stream transmitter.

Each of the functions shown in FIG. 10 can be provided by means of the stream unit having the hardware configuration shown in FIG. 2. For a method for providing each of the functions, a selection could be made of a plurality of methods as with the stream receiver shown in FIG. 3. A method for providing any of the functions shown in FIG. 4 is not particularly limited to what is described herein.

In FIG. 11, reference numeral 1101 denotes a stream receiver according to this embodiment; 1102, data transmitted and received to and from a network; 1103, an external input such as a user input to a device controller 1104; 1104, a device controller for controlling the entire stream receiver; 1105, a communications function unit for transmitting and receiving data to and from another unit via a network; 1106, a stream controller for decoding stream data outputted by the communications function unit 1105; 1107, a display function unit for displaying and reproducing the stream data decoded by the stream controller 1106; and 1108, a stream selector for selecting stream data to be received according to instructions from a received-stream linking unit 1011 of a stream transmitter.

Each of the functions shown in FIG. 11 can be provided by the stream unit having a hardware configuration shown in FIG. 2. One method for mounting one function is by describing any of the functions shown in FIG. 11 through a program, storing the program in the memory 203, and then executing the program on the CPU 202. Another method for mounting a function could be by providing part of any function through software and the rest of the function by means of hardware, for example, such as providing part of a communications function through a program and the rest of the function by means of the communications function unit 1105.

Still another method for mounting a function could be by providing all parts of any function as hardware. In addition, each of the methods mentioned above could be selected independently of one another for each given function. It would be possible, for example, to provide all of stream control unit by means of hardware, communications function unit by means of mixture of a program and hardware, and the other functions by means of software. Methods for providing individual given functions are not limited to what is described herein.

The operation of the transmitted-stream linking unit 1011 and the stream selector 1108, both according to this embodiment is described below with reference to FIG. 12. In FIG. 12, the transmitted-stream linking unit P denotes the transmitted-stream linking unit 1011 of the stream transmitter 1001 P, the transmitted-stream linking unit Q denotes the transmitted-stream linking unit 1011 of the stream transmitter 1001Q, and the stream selector R denotes the stream selector 1108 of the stream receiver 1101 R. In FIG. 12, the stream transmitter 1001 P and the stream transmitter 1001 Q are connected to the stream receiver 1101 R via a network and can transmit and receive stream data to and from each other. In this embodiment, a processing flow is shown for transmission of stream data A from the stream transmitter 1001 Q to the stream receiver 1101 R.

The stream transmitter 1001 Q cannot continuously transmit stream data A for some reason. At processing stage 1202, the transmitted-stream linking unit Q of the stream transmitter 1001 Q requests the stream transmitter 1001 P to make a reservation for the transmission of the same as, similar to or associated with the stream data A. In this embodiment, the operation of the stream transmitter 1001 P having stream data designated is described below.

At processing stage 1203, the stream transmitter 1001 P notifies the stream transmitter 1001 Q of a response to the reservation. At processing stage 1204, the stream transmitter 1001 Q then requests the stream transmitter 1001 P to transmit a designated stream to the transmitter 1001 Q. At processing stage 1205, the stream transmitter 1001 P sends a response to the request for designated stream data transmission back to the stream transmitter 1001 Q. At processing stage 1206, the stream transmitter 1001 P then requests the stream selector 1108 R of the stream receiver 1101 R to switch a stream transmitter for stream data being received. At processing stage 1207, the stream receiver 1101 R notifies the stream transmitter 1001 P that a stream transmitter can be switched. At processing stage 1208, the stream transmitter 1001 P starts transmitting the stream data designated to the stream transmitter 1001 Q.

According to this embodiment, the stream transmitter 1001 is provided with the transmitted-stream linking unit 1011 and the stream receiver 1101 is provided with the stream selector 1108. Another stream transmitter 1101 can therefore continuously transmit to the stream receiver 1101 stream data that is the same as, similar to, or associated with stream data being transmitted even if one stream transmitter 1101 discontinues the transmission of stream data being transferred for some reason, thus allowing improvements in the quality of the transmitted stream data.

The present invention is available in a network system capable of transmitting and receiving stream data such as video image and audio information. The quality of received stream data can be improved by providing a stream receiver having stream selection unit, stream comparison unit, and stream switching unit or a stream transmitter having transmitted-stream linking unit.

The provision of received-stream linking unit for a stream receiver makes it possible for a plurality of stream receivers to link and obtain same, similar or associated stream data and a plurality of received stream data obtained, thus allowing improvements in the quality of the received stream data.

What is claimed is:

1. A network system comprising:
a stream transmitter which transmits stream data; and,
a stream receiver which obtains stream data from said stream transmitter;
wherein said stream receiver comprising:
communications function unit which receives a plurality of stream data containing same, similar or associated video or audio information;
stream comparison unit which compares reproduction and synchronization information such as time stamp information on the plurality of stream data; and
stream switching unit which switches the plurality of received stream data according to a comparison result of said stream comparison unit.

2. A network system comprising:
a stream transmitter which transmits stream data; and,
a stream receiver which obtains stream data from said stream transmitter;
wherein said stream receiver comprising:
communications function unit which receives stream data;
received-stream linking unit which selects stream data to be received while sharing at least part of information associated with stream data with another stream receiver; and
stream switching unit which switches received stream data according to the stream data selection by said received-stream linking unit.

3. A stream receiver capable of obtaining stream data from a stream transmitter, said stream receiver comprising:
communications function unit which receives a plurality of stream data containing same, similar or associated video or audio information;
stream comparison unit which compares reproduction and synchronization information such as time stamp information on the plurality of stream data; and
stream switching unit which switches the plurality of received stream data according to a comparison result from said stream comparison unit.

4. A stream receiver capable of obtaining stream data from a stream transmitter, said stream receiver comprising:
communications function unit which receives stream data;
received-stream linking unit which selects stream data to be received while sharing at least part of information associated with stream data with another stream receiver; and
stream switching unit which switches received stream data according to the stream data selection by said received-stream linking unit.

5. A method for controlling a network including a stream transmitter which transmits stream data and a stream receiver which obtains stream data from said stream transmitter, said method comprising the steps of:
receiving a plurality of stream data containing the same, similar or associated video or audio information;
comparing reproduction and synchronization information including time stamp information on the plurality of stream data; and
switching the plurality of received stream data according to a result of said comparison.

6. A method for controlling a network including a stream transmitter which transmits stream data and a stream receiver which obtains stream data from said stream transmitter, said method comprising the steps of:
receiving stream data;
designating stream data to be received while sharing at least part of information associated with stream data with another stream receiver; and
switching stream data to be received according to said result.

7. The stream receiver according to claim 3, further comprising stream selection unit which selects stream data on video or audio information that is the same as, similar to or associated with stream data being received.

8. The stream receiver according to claim 3, wherein said communications function unit simultaneously receives both stream data A being received and stream data B at least for a given period of time, the stream data B being selected by stream selection unit which selects stream data on video or audio information that is the same as, similar to or associated with stream data being received;
said stream comparison unit compares reproduction and synchronization information including time stamp information on the stream data A and B and determining a coincidence between both the stream data based on a prescribed coincidence determination rule; and
said stream switching unit switches the stream data A to the stream data B according to a comparison result from said stream comparison unit.

9. The stream receiver according to claim 3, wherein said stream receiver records stream data A being received and stream data B and merges the stream data A and the stream data B recorded during or after recording, the steam data B being selected by stream selection unit which selects stream data on video or audio information that is the same as, similar to or associated with stream data being received.

10. The stream receiver according to claim 3, wherein said stream receiver records stream data A being received and stream data B and continuously reproduces the stream data B after reproducing the stream data A recorded, the stream data B being selected by stream selection unit which selects stream data on video or audio information that is the same as, similar to or associated with stream data being received.

11. A network system comprising:
a stream transmitter which transmits stream data; and
a stream receiver which obtains stream data from said stream transmitter;
wherein said stream transmitter include transmitted-stream linking unit which shares at least part of information associated with stream data with another stream transmitter, selecting stream data containing video or audio information that is the same as, similar to or associated with stream data that another stream transmitter is transmitting, and notifying the stream receiver of information on the stream data selected; and
wherein said stream receiver includes stream selection unit capable of obtaining information on stream data selected by said stream transmitter and notifying communications function unit of stream data switching.

12. A stream transmitter which transmits stream data, comprising:
transmitted-stream linking unit which shares at least part of information associated with stream data with another stream transmitter, selecting stream data containing video or audio information that is the same as, similar to or associated with stream data that another stream transmitter is transmitting, and notifying a stream receiver of information on the stream data selected.

13. A stream receiver according to claim 4, further comprising stream selection unit capable of obtaining information on stream data selected by said stream transmitter and notifying said communications function unit of stream data switching.

14. A stream receiver comprising:
communications function unit which receives stream data;
received-stream linking unit which selects stream data to be received while sharing at least part of information associated with stream data with another stream receiver;
stream switching unit which switches stream data to be received according to the stream data selection by said received-stream linking unit; and
stream data recording unit capable of transferring stream data having stream data being received recorded to and obtaining stream data from another stream receiver.

15. The stream receiver according to claim 14, wherein said stream recording unit is capable of recording stream data A received and stream data B transferred from another stream receiver and merging said stream data A and said stream data B.

16. A stream receiver comprising:
communications function unit which receives stream data;
received-stream linking unit which selects stream data to be received while sharing at least part of information associated with stream data with another stream receiver;
stream switching unit which switches stream data to be received according to the stream data selection by said received-stream linking unit; and
utilization detection unit which detects a user's use of said stream receiver;
wherein said received-stream linking unit switches a stream receiver for receiving stream data, based on information on the user's use of said stream receiver detected by said utilization detection unit.

17. A stream transmitting and receiving unit which transmits and receives stream data, comprising:
communications function unit which receives a plurality of stream data containing same, similar or associated video or audio information;
stream comparison unit which compares reproduction and synchronization information including time stamp information on the plurality of stream data;
stream switching unit which switches the plurality of received stream data according to a comparison result from said stream comparison unit; and
transmitted-stream linking unit which shares at least part of information associated with stream data with another stream transmitting and receiving unit, selecting stream data containing video or audio information that is the same as, similar to or associated with stream data being transmitted, and notifying a stream transmitting and receiving unit of information on stream data selected.

18. A stream transmitting and receiving unit which transmits and receives stream data, comprising:
communications function unit which receives stream data;
received-stream linking unit which selects stream data to be received while sharing at least part of information associated with stream data with another stream receiver;
stream switching unit which switches stream data to be received according to the stream data selection by said received-stream linking unit; and
transmitted-stream linking unit which shares at least part of information associated with stream data with another stream transmitting and receiving unit, selecting stream data containing video or audio information that is the same as, similar to or associated with stream data being transmitted, and notifying a stream transmitting and receiving unit of information on the stream data selected.
